(19) United States
(12) Patent Application Publication
(10) Pub. No.: US 2004/0086775 A1
(43) Pub. Date: May 6, 2004

(54) Fuel cell having a variable gas diffusion layer

(76) Inventors: Greg A. Lloyd, Spokane, WA (US); Lijun Bai, Spokane, WA (US); Shiblihanna I. Bayyuk, Spokane, WA (US)

Correspondence Address: WELLS ST. JOHN P.S., 601 W. FIRST AVENUE, SUITE 1300, SPOKANE, WA, 99201, US

(21) Appl. No.: 10/289,694

(22) Filed: Nov. 6, 2002

(51) Int. Cl. H01M 4/94; H01M 8/10

(52) U.S. Cl. 429/44; 429/30; 429/32; 429/26; 429/42

(57) ABSTRACT

A fuel cell is described and which includes an ion exchange membrane having opposite anode and cathode sides; an electrode disposed adjacent to each of the anode and cathode sides; a gas diffusion layer which is located adjacent to each electrode and which defines a major surface and wherein at least one of the gas diffusion layers has a hydrophobicity which varies when measured in a direction which is substantially along the major surface, and which provides a substantially optimal hydration for the ion exchange membrane at fuel cell operational temperatures; an airflow is provided to the fuel cell and which is supplied in part to the cathode, and wherein the airflow further regulates the operational temperature of the fuel cell.

### TECHNICAL FIELD

The present invention relates to a fuel cell, and more specifically to a fuel cell having a gas diffusion layer which is located adjacent to each electrode and which defines a major surface and wherein the gas diffusion layer has a hydrophobicity which varies when measured in a direction which is substantially along the major surface.

### BACKGROUND OF THE INVENTION

A fuel cell is a device which can readily convert chemical energy into electrical and heat energy by the reaction of a fuel gas with a suitable oxidant supply. In a proton exchange membrane fuel cell, for example, the fuel gas is typically hydrogen, and the oxidant supply comprises oxygen (or more typically ambient air). In fuel cells of this type, a membrane electrode diffusion layer assembly is provided, and which includes a solid polymer electrolyte which has opposite anode and cathode sides. Appropriate electrodes are provided on the opposite anode and cathode sides. During operation, fuel gas reacts in the presence of a catalyst which is incorporated into the electrode on the anode side to produce hydrogen ions which migrate through the solid polymer electrolyte to the opposite cathode side. Meanwhile, an oxidant supply introduced to the cathode side is present to react with the hydrogen ions in the presence of the catalyst which is incorporated into the electrode on that side to produce water and a resulting electrical output.

Many fuel cell designs have been provided through the years and much research and development activity has been conducted to develop a fuel cell which meets the perceived performance and cost per watt requirements of various users. Despite decades of research, fuel cells have not been widely embraced except for narrow commercial applications. While many designs have emerged, and which have operated with various degrees of success, shortcomings in some peculiar aspect of their individual designs have resulted in difficulties which have detracted from their widespread commercial acceptance and perceived usefulness.

For example, one of the perceived challenges for fuel cell designers is the reduction of contact resistance between the current collector and an adjacent gas diffusion layer which is borne by the membrane electrode diffusion layer assembly. This contact resistance is, generally speaking, inversely related to the power output of the fuel cell. Consequently, lowering the contact resistance increases the overall electrical output of the fuel cell.

Still further, fuel designers have long recognized that as a fuel gas and oxidant is supplied or directed over an active area of an ion exchange membrane which is incorporated therein, several interrelated, and competing factors may come into play, and which may vary the performance of the fuel cell. These several factors that are involved in the performance of the fuel cell and the ion exchange membrane include the relative hydration of the ion exchange membrane; the concentration of the fuel and/or oxidant; and the relative temperature of the reactants and the ion exchange membrane itself. In this regard when fuel cells are designed, particular care is taken to substantially optimize the diffusion layers which are made integral with the ion exchange membrane relative to perceived operational conditions under which the fuel cell may operate.

As might be expected, as operational conditions change, these competing factors may begin to vary across the face of the active area of the membrane electrode diffusion layer assembly. As a result, the specific characteristics of the respective diffusion layers often becomes suboptimal. For example, a once optimal degree of porosity and/or permeability and hydrophobicity at a predetermined location on the ion exchange membrane may, in view of the location where the fuel gas is introduced, become suboptimal. Such may also be the case at the bleed or exhaust area of the membrane electrode diffusion layer assembly where excess fuel gas, water, and other by products are removed from the fuel cell.

In traditional fuel cell stack designs, for example, a great deal of attention has been paid to the design of fuel flow channels in order to substantially optimize the current output across the entire active area. However, notwithstanding the attempts of the prior art, even in air-cooled, planar, fuel cell stack designs, the hydration of the membrane electrode diffusion layer assembly, and ultimately its performance, varies as the fuel, gas, and air travel across the surface of the fuel cell active area.

A fuel cell having a variable gas diffusion layer which addresses these and other perceived shortcomings in the prior art practices is the subject matter of the present application.

### SUMMARY OF THE INVENTION

A first aspect of the present invention relates to a fuel cell having an ion exchange membrane with opposite anode and cathode sides; an electrode disposed adjacent to each of the anode and cathode sides; a gas diffusion layer which is located adjacent to each electrode, and which defines a major surface, and wherein at least one of gas diffusion layers has a hydrophobicity which varies when measured in a direction which is substantially along the major surface and which provides a substantially optimal hydration for the ion exchange membrane at fuel cell operational temperatures; and an airflow provided to the fuel cell and which is supplied, in part, to the cathode and wherein the airflow further regulates the operational temperature of the fuel cell.

A further aspect of the present invention relates to a fuel cell which includes an ion exchange membrane having opposite anode and cathode sides; an electrode juxtaposed relative to each of the anode and cathode sides; and a gas diffusion layer juxtaposed relative to each electrode, and which is defined by X, Y AND Z axes and wherein at least one of the gas diffusion layers further has both a variable porosity or permeability and hydrophobicity when measured in the X and Y axes.

Another aspect of the present invention relates to a fuel cell which includes an ion exchange membrane having opposite anode and cathode sides; an electrode juxtaposed relative to each of the anode and cathode sides; a gas diffusion layer positioned on at least one of the anode or cathode sides, and which has a length, width and thickness dimensions, and inwardly and outwardly facing surfaces, and wherein the length and width dimensions define a major surface, and wherein the inwardly facing surface of the gas diffusion layer is juxtaposed relative to the electrode; and a porous metal coating is borne by the outwardly facing surface of the gas diffusion layer and which has the effect of varying the hydrophobicity of the gas diffusion layer when the hydrophobicity is measured in a direction substantially along the major surface.

Still another aspect of the present invention relates to a fuel cell which includes an ion exchange membrane having opposite anode and cathode sides; an electrode disposed adjacent to each of the anode and cathode sides, and wherein the ion exchange membrane, during operation of the fuel cell, has a variable temperature and/or hydration region which has a higher relative temperature and/or hydration than an adjacent region; and a gas diffusion layer which is located adjacent to each electrode, and wherein at least one of the gas diffusion layers has a variable hydrophobicity which provides an appropriate hydration for the variable temperature and/or hydration region of the ion exchange membrane.

Yet a further aspect of the present invention relates to a fuel cell which includes an ion exchange membrane having opposite anode and cathode sides; an electrode disposed adjacent to each of the anode and cathode sides, and wherein the fuel cell during operation has an operational temperature range, and wherein the ion exchange membrane during operation has a region which has a higher relative temperature and/or hydration than an adjacent region; a gas diffusion layer which is located adjacent to each electrode and wherein at least one of the gas diffusion layers has a variable hydrophobicity and which provides an appropriate hydration for the region of the ion exchange membrane having a higher relative temperature and/or hydration, and an airflow provided to the fuel cell and that cathode thereof, and wherein the airflow regulates the operational temperature of the fuel cell.

Another aspect of the present invention relates to a method for optimizing the operation of a fuel cell and which includes providing a fuel cell having an ion exchange membrane with opposite anode and cathode sides, and a surface area; determining the surface area temperature and/or hydration of the ion exchange membrane during operation of the fuel cell to identify regions of the ion exchange membrane which have different surface temperatures and amounts of hydration, and correspondingly different operational hydration requirements; providing a gas diffusion layer made integral with the ion exchange membrane, and which has a variable hydrophobicity and which provides for substantially optimal hydration for the regions of the ion exchange membrane which have a different surface temperature and operational hydration requirements; and regulating the operational temperature of the fuel cell.

These and other aspects of the present invention will be discussed in further detail hereinafter.

### BRIEF DESCRIPTION OF THE DRAWINGS

Preferred embodiments of the invention are described below with reference to the following accompanying drawings.

FIG. 1 is a somewhat simplified, and exaggerated depiction of a membrane electrode diffusion layer assembly which employs the teachings of the present invention.

FIG. 2 is a somewhat simplified, and exaggerated depiction of a membrane electrode diffusion layer assembly which illustrates a second form of the present invention.

FIG. 3 is a somewhat simplified, and exaggerated depiction of a membrane electrode diffusion layer assembly which illustrates still another form of the present invention.

FIG. 4 is a somewhat simplified, and exaggerated depiction of a membrane electrode diffusion layer assembly which illustrates yet another form of the present invention.

FIG. 5 is a graphic depiction of fuel cell voltage versus current density for a fuel cell having a membrane electrode diffusion layer assembly which utilizes the teachings of the present invention.

FIG. 6 is a graphic depiction of fuel cell voltage versus current for a fuel cell membrane electrode diffusion layer assembly and which employs the teachings of the present invention.

FIG. 7 is a graphic depiction of peak electrical power output at 0.6 volts versus air intake temperature in a fuel cell which employs a membrane electrode diffusion layer assembly and which utilizes the teachings of the present invention.

FIG. 8 is a graphic depiction of fuel cell voltage versus current in a fuel cell which employs a membrane electrode diffusion layer assembly and which utilizes the teachings of the present invention.

FIG. 9 is a fragmentary, transverse, vertical, sectional view of an ion exchange membrane fuel cell which utilizes the teachings of the present invention.

FIG. 10 is a graphic depiction of current density; pressure; and fuel cell ESR for a fuel cell employing a membrane electrode diffusion layer assembly of the present invention.

FIG. 11 is a perspective, side elevational view of an ion exchange membrane fuel cell module which employs the teachings of the present invention.

FIG. 12 is a perspective view of a second form of an ion exchange fuel cell module which employs the teachings of the present invention.

FIG. 13 is a perspective view of an ion exchange membrane fuel power system which may incorporate the teachings of the present invention as shown in FIG. 9.

### DETAILED DESCRIPTION OF THE PREFERRED EMBODIMENTS

This disclosure of the invention is submitted in furtherance of the constitutional purposes of the U.S. Patent Laws “to promote the progress of science and the useful arts” (Article 1, Section 8).

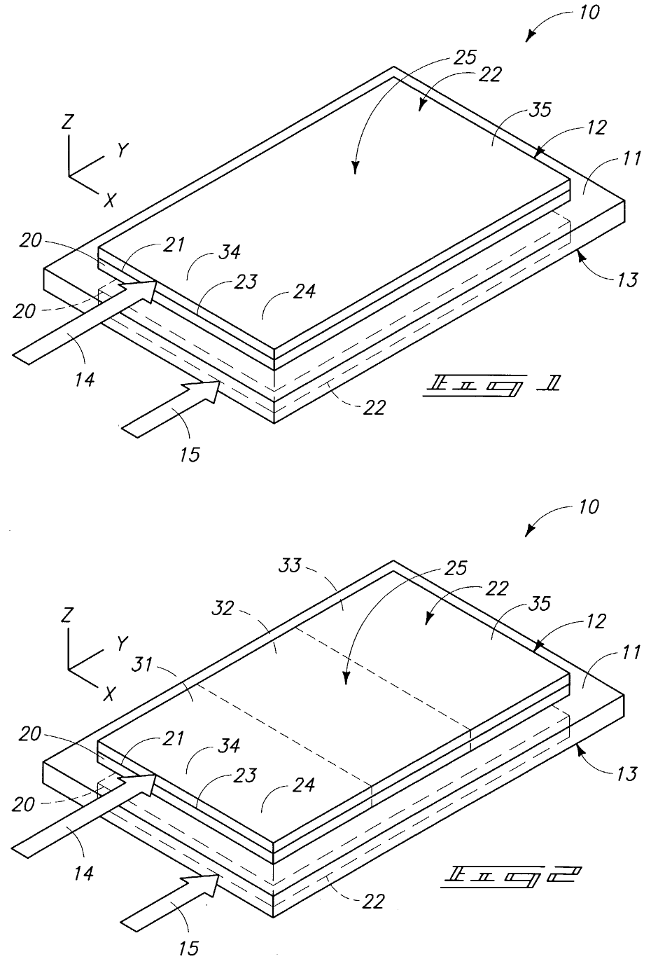

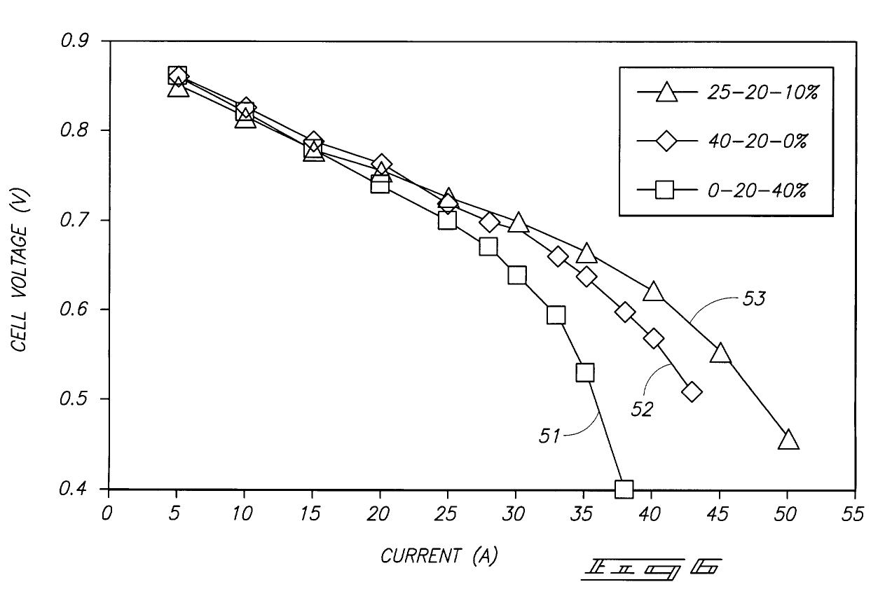

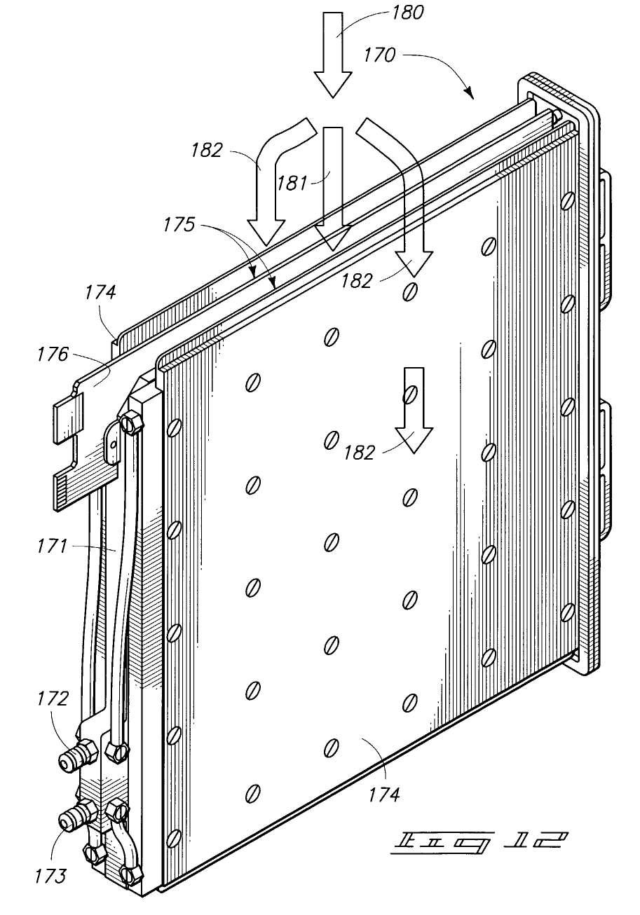

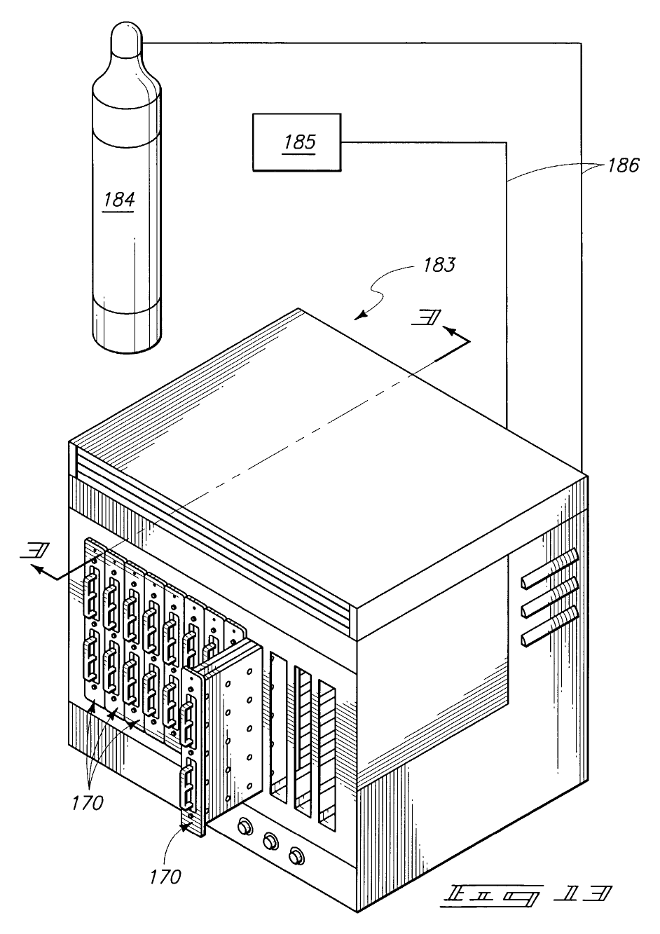

FIG. 1 is a greatly enlarged, perspective view of a membrane electrode diffusion layer assembly 10 which employs the teachings of the present invention. The membrane electrode diffusion layer assembly (MEDLA) is received within, or made integral with, an ion exchange membrane fuel cell module such as what is depicted in FIGS. 11 and/or 12, the features of which will be discussed in greater detail hereinafter. For purposes of the present discussion, however, the MEDLA 10, as will be disclosed below, is useful in fuel cells which operate at temperatures of less than about 300° C. Consequently, this invention is not useful in solid oxide fuel cell designs, and other fuel cells which generally operate at temperatures greater than about 300° C. As will be appreciated by a study of FIGS. 1-4, for example, various aspects of the construction of the MEDLA 10 can be expressed in terms of dimensions as measured substantially along the X, Y and Z axes. In this regard the X and Y axes related to the length and width dimension of an object, and the Z axis relates to the thickness of the same object. As seen in FIG. 1, and following, a fuel cell employing the present invention will typically utilize an ion exchange membrane 11, such as may be purchased under the trade name “Nafion”. This ion exchange membrane 11 is a thin, flexible, and sheet-like material which is made from a sulfonated fluoropolymer. This ion exchange membrane is available from the Dupont™ company. The ion exchange membrane 11 has opposite anode and cathode sides 12 and 13 respectively. As seen in FIGS. 1-4, the anode side 12 of the MEDLA 10 can be provided with a fuel supply which is generally indicated by the numeral 14. Still further, the opposite cathode side 13 is provided with an oxidant or air supply which is generally indicated by the numeral 15. As will be discussed in greater detail with respect to specific forms of ion exchange membrane fuel cells which employ the present invention, the air supply 15 which is provided to the MEDLA 10 also provides a convenient means for regulating the overall operational temperature of the fuel cell. For example, in one form of the invention (FIG. 11), a preponderance of the heat energy generated during fuel cell operation is removed by way of the air supply 15 which is provided to the cathode side 13 of the ion exchange membrane 11. In another form of the invention (FIG. 12), less than a preponderance of the heat energy is removed by way of the air supply provided to the cathode side of the ion exchange membrane.

As will be seen from a study of FIGS. 1-4, an electrode layer 20 is disposed in ion exchanging relation relative to the respective anode and cathode sides 12 and 13, respectively. The electrode layer 20 is of conventional design, and which, during fuel cell operation, facilitates the generation and movement of ions across the ion exchange membrane 11. Each electrode layer 20 has an outwardly facing surface 21. As seen in FIG. 1 a gas diffusion layer 22 is borne by, or otherwise juxtaposed relative to the outwardly facing surface 21 of the electrode layer 20. In one form of the invention, the gas diffusion layer 22 is applied as a carbon based slurry which may be modified, as needed, to provide different levels or degrees of hydrophobicity and porosity for the anode and cathode sides 13 and 14, respectively.

As used in this application, the word porous means the volume of interstices of a material relative to the volume of the mass of the material. Porosity effects the state of permeability of a material, that is the property of a porous material that is the measure of the amount (rate or volume) at which a fluid (liquid or gas) passes through a unit of cross-section of material at a given viscosity, under a unit of gradient pressure. Therefore, at fixed gradient pressure, and viscosity, the permeability of a given material is directly related to its porosity. For purposes of this application, therefore, the terms porosity and permeability may be used interchangeably with the understanding that an increase in porosity (interstical volume) will normally result in an increase in permeability, and vice versa.

In the present invention, the gas diffusion layer 22 may be modified, as provided below, to achieve improved performance characteristics by providing effective and substantially uniform hydration of the ion exchange membrane 11. While the gas diffusion layer 22, as shown in FIGS. 1-4, is illustrated as a single layer, this same gas diffusion layer, as will be discussed below, may include individually discrete layers each having a different porosity (permeability) and hydrophobicity.

As best illustrated in FIGS. 1-4, it will be seen that the outwardly facing surface 24 of each gas diffusion layer 22 defines a major surface 25. In the present invention, at least one of the gas diffusion layers 22 located on the anode or cathode side 12 and 13 has a hydrophobicity which varies when measured in a direction which is substantially along the major surface 25 and which facilitates substantially optimal hydration of the ion exchange membrane 11 at fuel cell operating temperatures. For example, as seen in FIG. 1, the gas diffusion layer 22 which is juxtaposed relative to the anode side 12 and cathode side 13 of the ion exchange membrane 11 may both have a variable hydrophobicity. In the alternative, it is possible that only one of the anode or cathode sides has a variable hydrophobic gas diffusion layer 22. Still further in another form of the invention, the gas diffusion layer 22 may have a hydrophobicity which varies when measured in the X axis; Y axis; X and Y axes; and X, Y and Z axes. As should be understood by a study of FIGS. 1-4, the oxidant 15 and fuel supplies 14 each have a direction of flow as indicated by the arrows relative to the major surface 25. As will appreciated, the hydrophobicity of the respective gas diffusion layers may vary when measured in substantially the same general direction of flow of the fuel supply 14; and/or oxidant supply 15.

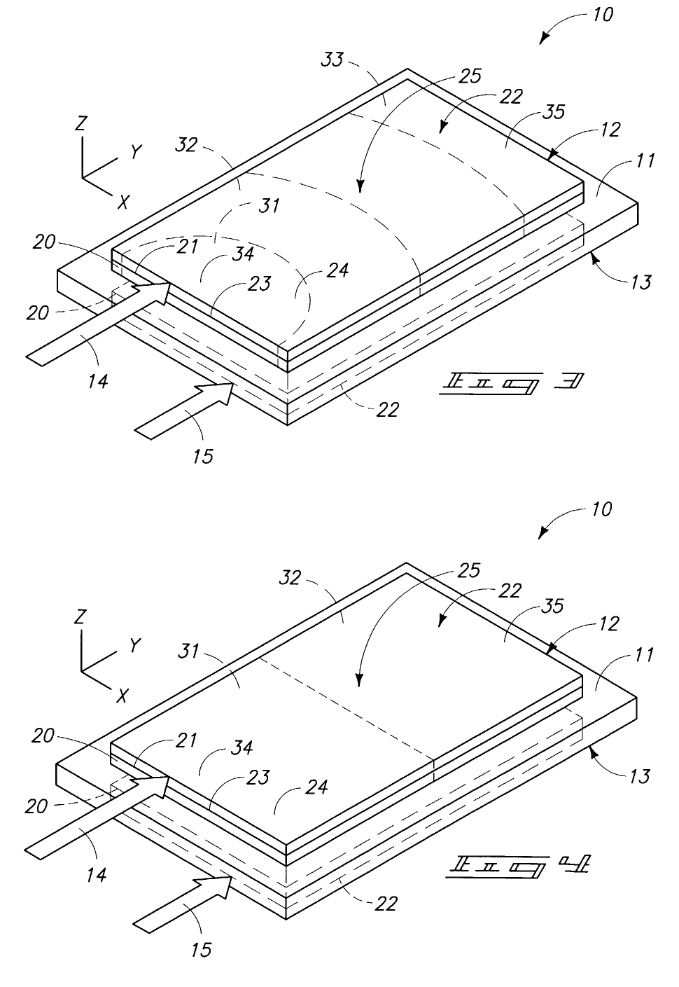

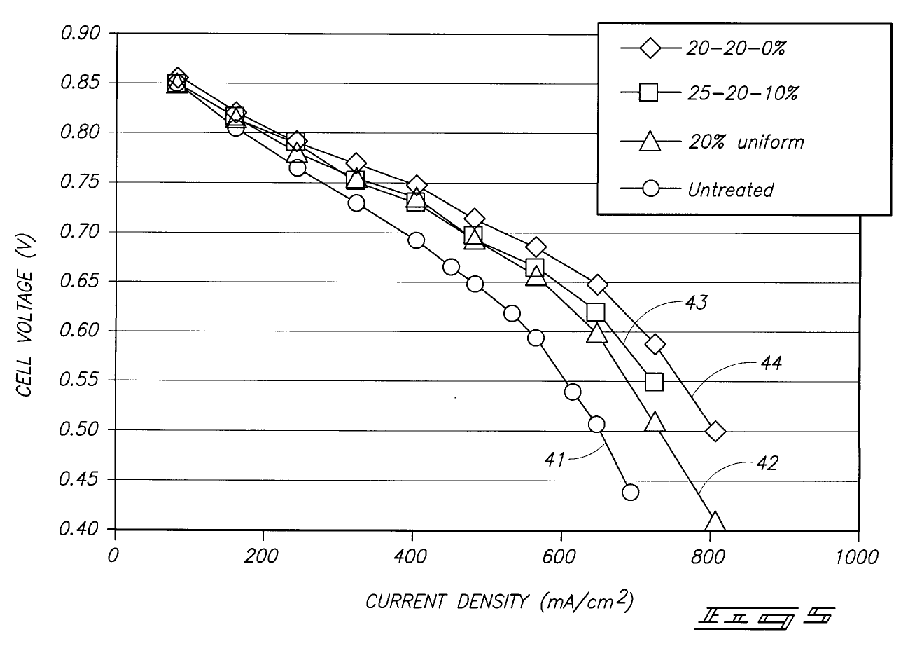

As seen in FIG. 2, and in an alternative form of the invention, the ion exchange membrane 11 includes a gas diffusion layer 22 having discrete first, second and third zones 31, 32 and 33 respectively. The respective discrete zones may each have individually unique yet substantially constant hydrophobicity. However, in one form of the invention, the relative hydrophobicity of the respective zones may be variable or a mixture of substantially constant and variable hydrophobicity zones. Still referring to FIG. 2, in still another form of the invention, where the gas diffusion layer 22 has a plurality of discrete zones 31, 32 and 33, one of the discrete zones may have a continuously variable hydrophobicity; and the hydrophobicity of the remaining zones are variable and different in degree of their respective hydrophobic natures from the continuously variable one. Yet further, in another form of the invention the discrete zones 31-33 may have substantially similar surface areas, and the hydrophobicity of the respective discrete zones is variable. As seen in FIG. 3, and in another form of the invention, the gas diffusion layer 22 as provided on the anode side 12 of the ion exchange membrane 11 has a plurality of discrete zones 31, 32 and 33 respectively, and wherein at least one of the discrete zones has a surface area which is dissimilar from the remaining discrete zones. In this arrangement, the hydrophobicity of the discrete zones 31, 32 and 33 may be varied in assorted combinations. In each of the forms of the invention as seen in FIGS. 1-4, the gas diffusion layer 22 includes a plurality of discrete zones 31-33, each of which has a surface area, and wherein the hydrophobicity and surface area of the respective zones are varied to provide a substantially favorable hydration of the ion exchange membrane 11. In addition to providing optimal hydration, the hydrophobicity and surface area of the respective zones 31-33 may be varied to provide a substantially enhanced current density for the ion exchange membrane 11 as will be discussed, hereinafter. Moreover, in each of the forms of the invention, where a plurality of discrete zones 31, 32 and 33 are provided, it is possible for the hydrophobicity and the surface area of the respective zones to be varied to provide both a substantially favorable hydration and enhanced current density for the ion exchange membrane 11. Still further, in those forms of the invention as shown in FIGS. 1-4 that include a plurality of discrete zones, the gas diffusion layer 22 may be provided with a variable porosity (permeability). In this arrangement, the hydrophobicity, porosity (permeability) and surface area of the respective zones may be varied to provide both substantially optimal hydration and enhanced current density for the ion exchange membrane 11.

As discussed above, the ion exchange membrane 11 is provided with fuel and oxidant supplies 14 and 15, respectively, and which are each introduced to the ion exchange membrane at a first location 34 which is located along the major surface 25. Further, any remaining fuel, oxidant, or any byproducts are removed from the ion exchange membrane 11 at a second location or bleed 35 which is located along the major surface 25. The oxidant and fuel supplies 14 and 15 move in a linear or nonlinear path of travel between the first and second locations. In the arrangements as shown in FIGS. 1-4, the hydrophobicity may vary when measured in substantially the same direction of flow of the respective paths of travel. In another form of the invention, the hydrophobicity may vary when measured in substantially the same general direction of flow as the fuel supply 14. Still further in other forms of the invention the hydrophobicity of the gas diffusion layer 22 is greatest at a location adjacent the first location 34, and is least when measured at a location adjacent to the second location 35. In still other forms of the invention the hydrophobicity of the gas diffusion layer 22 may be least when measured at a location adjacent the first location 34 and may be the greatest when measured at a location adjacent to the second location 35. In each of the non-limiting and representative examples, noted above, the hydrophobicity is varied in order to provide substantially uniform and appropriate hydration for the ion exchange membrane 11 and increased current density, both of which provide for improved performance for a fuel cell which incorporates the MEDLA 10.

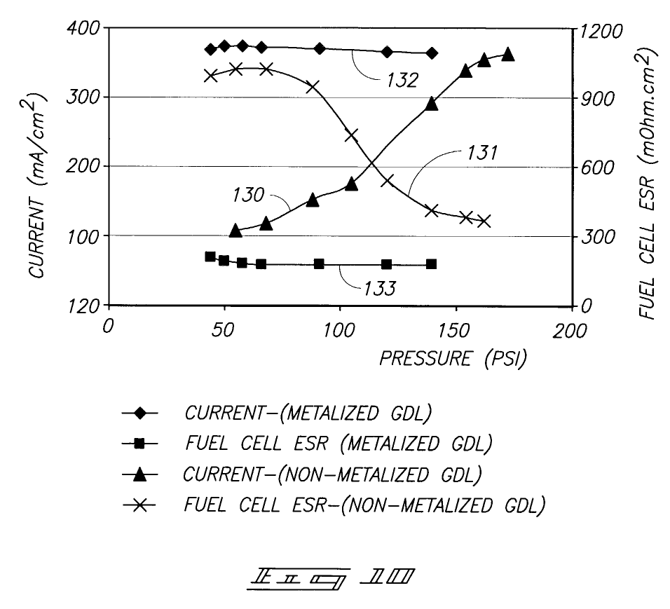

As will be discussed in greater detail with respect to FIG. 9, it should be understood that the gas diffusion layer 22 may comprise two portions which are juxtaposed or located closely adjacent to the outwardly facing surface 21 of the electrode 20. In this regard, the gas diffusion layer 22 may comprise a macro-diffusion layer which includes, in one form, a carbon fiber based sheet having a porosity, which is, as a general matter, greater than the porosity of an adjacent micro-diffusion layer which is made integral therewith. This macro-diffusion layer can be commercially purchased under the trade name “Toray”from various commercial sources. The micro-diffusion layer, which will be discussed in greater detail hereinafter, is made integral with a macro-diffusion layer. In combination these two layers define the gas diffusion layer 22. It should be understood that the gas diffusion layer 22, which is described herein, as including both a macro-diffusion layer, and a micro-diffusion layer, may in some forms of the invention include only one of these two previously described diffusion layers.

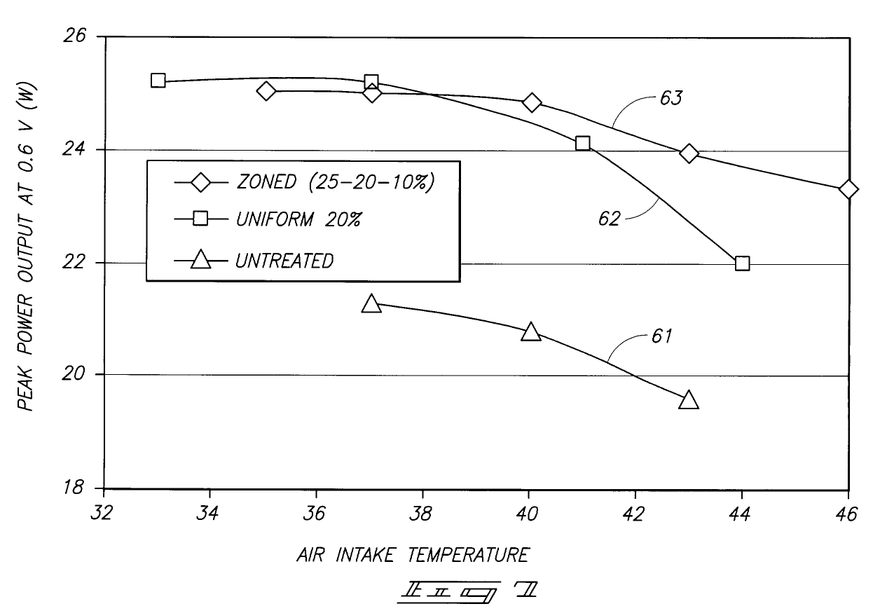

Referring now to FIG. 5, a graph is provided and which shows the relationship of current voltage versus current density as expressed in milliamps per square centimeter of surface area for four different MEDLA's 10 and which demonstrate some characteristics of the present invention. As will be seen in FIG. 5, the line label 41 graphically depicts an ion exchange membrane fuel cells performance employing a MEDLA 10 which has a gas diffusion layer 22 which has not been treated in any fashion to provide an enhanced or variable hydrophobicity. The line label 42 in FIG. 5 depicts the performance of an ion exchange membrane fuel cell utilizing a MEDLA 10 which is provided with a gas diffusion layer 22 which is fabricated in a fashion so as to have a micro-diffusion layer which has a substantially uniform TEFLON ™ (PTFE) content of about 20% and a particulate carbon content of about 80%. The PTFE renders the micro-diffusion layer hydrophobic. A comparison of lines 41 and 42 will reveal that providing a gas diffusion layer with an enhanced hydrophobicity markedly increases the performance characteristics of a fuel cell incorporating same. Still referring to FIG. 5, line 43 graphically illustrates the performance of an ion exchange membrane fuel cell incorporating a MEDLA 10, and wherein gas diffusion layer 22 includes first, second and third zones 31, 32 and 33, respectively. In this regard, the first zone 31 has a PTFE content of about 25%; the second zone has a PTFE content of about 20%; and the third zone has a PTFE content of about 10%. It will be seen by a comparison of line 43, with lines 41 and 42, that further enhanced performance characteristics, and higher current densities can be realized by providing a plurality of zones each having a different hydrophobicity. Referring now to line 44 in FIG. 5, the performance of a MEDLA 10 for use in an ion exchange membrane fuel cell is shown and which has a plurality of zones as earlier discussed. In this regard the first zone 31 has a PTFE content of about 20%; the second zone 32 has a PTFE content of about 20%; and the third zone 33 has substantially no PTFE content. As will be seen, further enhanced current densities and fuel cell voltages are realized in this gas diffusion layer 22 arrangement as compared with lines 41, 42, and 43 respectively.

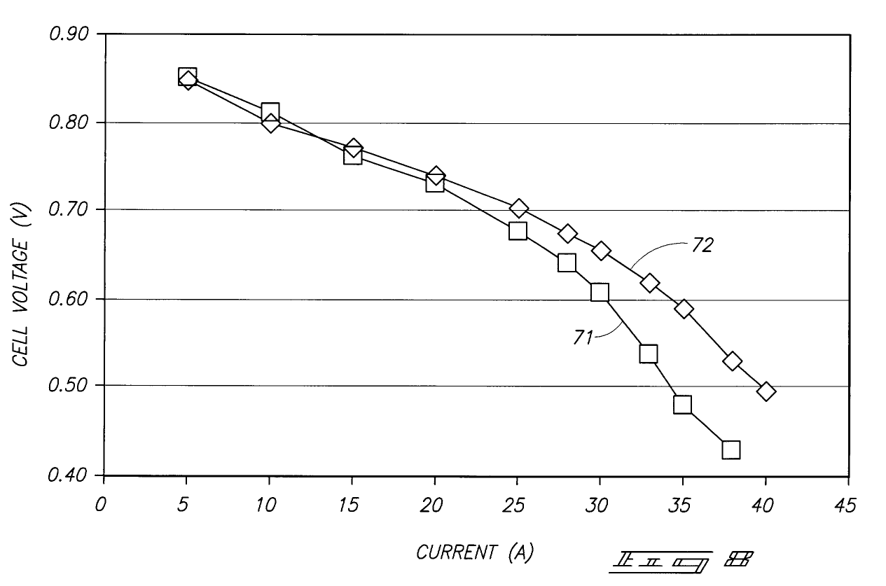

Referring now to FIG. 6 a second graph is provided and which further demonstrates other characteristics of the present invention. As seen in FIG. 6, line 51 depicts the performance of an ion exchange membrane fuel cell having a MEDLA 10 with a gas diffusion layer 22 and which has a plurality of zones 31, 32 and 33 respectively. The MEDLA 10 as depicted by line 51, has a first zone 31 which has substantially no PTFE content. The second zone 32 has a PTFE content of about 20%; and the third zone 33 has a PTFE content of about 40%. Referring now to line 52 in FIG. 6, the performance of an ion exchange membrane fuel cell is shown and wherein a MEDLA 10 incorporating the present invention includes a plurality of zones 30 having a variable hydrophobicity. As seen with respect to the line label 52, the first zone 31 has a PTFE content of about 40%; the second zone 32 has a PTFE content of about 20%; and the third zone has substantially no PTFE content. When compared with line 51 it is clear that line 52 depicts a fuel cell having substantially enhanced performance characteristics relative to current and voltage densities. Further, and referring to line 53, it will be seen that an ion exchange membrane fuel cell incorporating a MEDLA 10 having a plurality of zones 30 which includes a first zone 31 having a PTFE content of about 25%; a second zone 32 having a PTFE content of about 20%; and a third zone having a PTFE content of about 10% shows further enhanced performance characteristics relative to lines 51, and 52.

Referring now to FIG. 7 a graph is provided and which shows the peak power output for a fuel cell at an operating voltage of 0.6 volts (in watts), versus an air intake temperature for the same ion exchange membrane fuel cell. In this regard, line 61 depicts the performance characteristics of an ion exchange membrane fuel cell which employs a membrane electrode diffusion layer assembly 10 which has a gas diffusion layer 22 which has not been treated in any fashion to enhance its hydrophobic nature. Line 62 as depicted in FIG. 7 shows an ion exchange membrane fuel cell having a MEDLA 10 which has substantially uniform PTFE content of about 20%. A comparison of line 61 and 62 will show that the ion exchange membrane fuel cell employing a MEDLA 10 and having a substantially uniform hydrophobic nature provides enhanced performance characteristics for the ion exchange membrane fuel cell. Still further, and referring to line 63 in FIG. 7, the performance characteristics of an ion exchange membrane fuel cell is shown and which employs a MEDLA 10, which has a plurality of zones 30. In this regard the first zone 31 has a PTFE content of about 25%; the second zone 32 has a PTFE content of about 20%; and the third zone 33 has a PTFE content of about 10%. This clearly demonstrates that a MEDLA 10 having a gas diffusion layer 22 with a variable hydrophobicity provides enhanced performance characteristics for an ion exchange membrane fuel cell 11.

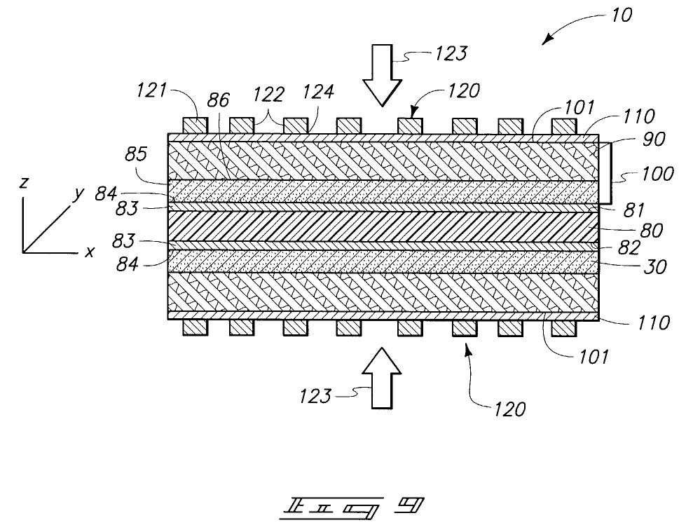

Referring now to FIG. 8, a graph is provided of a fuel cell voltage (in volts) versus current (in amps) as it relates to several ion exchange membrane fuel cells having different MEDLA 10 constructions. Line 71 depicts an ion exchange membrane fuel cell having a MEDLA 10 which includes a gas diffusion layer 22 and which is substantially untreated with respect to enhancing its hydrophobic nature. In contrast, line 72 depicts the performance characteristics of an ion exchange membrane fuel cell having a MEDLA 10 and which has a gas diffusion layer 22 located on the cathode side 13 of the ion exchange membrane 11, and which has a plurality of zones 30. In this regard, the cathode side 13 has a first zone 31 having a PTFE content of about 25%; a second zone 32 having a PTFE content of about 20%; and a third zone 33 having a PTFE content of about 15%. Still further, the anode side 12 is provided with a gas diffusion layer 22 which has a pair of zones 31 and 32 respectively. The first zone 31 on the anode side 12 has a PTFE content of about 5%; and the second zone 32 on the anode side is substantially untreated. As will be seen by comparing line 71 and 72, the fuel cell incorporating the MEDLA 10 having the construction as illustrated by line 72 has significantly enhanced performance characteristics relative to a fuel cell having a gas diffusion layer which is untreated.

Referring now to FIG. 9, another alternative form of membrane electrode diffusion layer assembly 10 is shown and which is useful when incorporated into an ion exchange membrane fuel cell which will be discussed in greater detail hereinafter. As seen in this form of the invention, an ion exchange membrane 80 such as may be purchased under the trade name “Nafion” is provided. As earlier discussed this ion exchange membrane is a thin, flexible and sheet-like material which is made from a sulfonated fluoropolymer. This ion exchange membrane has opposite anode and cathode sides 81 and 82 respectively. As seen in FIG. 9, an electrode layer 83 is disposed in ion exchanging relation relative to the respective anode and cathode sides 81 and 82 respectively. The electrode layer 83 is of conventional design. This electrode layer facilitates the creation of ions which subsequently move across the ion exchange membrane 80. Each electrode layer 83 has an outwardly facing surface 84. A micro-diffusion layer, or first portion 85, having a given degree of porosity is juxtaposed relative to the outwardly facing surface 84 of the electrode layer 83. The micro-diffusion layer 85 comprises a carbon based slurry which may be modified, as earlier discussed, to provide different levels of porosity and hydrophobicity for the anode and cathode sides 81 and 82 respectively. This of course may be varied in X, Y and/or Z axes. Still further the porosity (permeability) and hydrophobicity of the micro-diffusion layer 85 may be manipulated, as discussed above, in various ways to achieve various desired performance characteristics such as providing effective hydration of the ion exchange membrane 80. Yet further while the micro-diffusion layer 85 is shown as a single layer the micro-diffusion layer may comprise individually discrete layers each having a different porosity (permeability) and hydrophobicity. Similarly, as was discussed earlier with respect to FIGS. 1-4, the hydrophobicity and porosity of each of these several layers may be varied substantially in a direction along the major surface 25. The micro-diffusion layer has an outwardly facing surface 86.

Referring still to FIG. 9, it will be seen that a macro-diffusion layer or second portion 90 is provided and which is juxtaposed relative to the outwardly facing surface 86 of the micro-diffusion layer 85. The macro-diffusion layer 90 comprises, in one form, a carbon fiber based sheet having a porosity (permeability), which is, as a general matter, greater than the porosity (permeability) of the micro-diffusion layer 85. This macro-diffusion layer may be commercially purchased under the trade name “Toray” from various commercial sources. The micro-diffusion layer 85 and the macro-diffusion layer 90 in combination define a gas diffusion layer (GDL) which is generally indicated by the numeral 100. The gas diffusion layer 100 has an outwardly facing surface area 101 which has a surface texture or topology. It should be understood that the gas diffusion layer 100 while described herein as including both the macro-diffusion layer 90 and a micro-diffusion layer 85 may, in some forms of the invention, include only one of these two previously described diffusion layers. It being understood that FIG. 9 shows a preferred form of practicing the invention. The porosity (permeability) and hydrophobicity of the macro-diffusion layer 90 may be varied in assorted ways in the X, Y and Z axes. The gas diffusion layer 100 has an outwardly facing surface 101.

Referring still to FIG. 9 it will be seen that a porous metal coating 110 comprising one or more elements selected from the Periodic Table of Elements and which has an atomic number of 13 to 75 is positioned at least in partial covering relation relative to the outwardly facing surface area 101 of the gas diffusion layer 100. This metal coating forms a resulting metalized gas diffusion layer 100. The porous metal coating 110 may comprise an alloy; oxide; nitride; or carbide. In FIG. 9 the gas diffusion layer 100 and the porous metal coating 110 are disposed on both the anode and cathode sides 81 and 82. However, it will be appreciated that the gas diffusion layer 100, and the porous metal layer 110 be disposed on only one of the anode or cathode sides 81 and 82 respectively. Yet further it is possible to fabricate a membrane electrode diffusion layer assembly 10 wherein the gas diffusion layer 100 is located on both the anode and cathode sides 81 and 82 respectively and the porous metal coating 110 is positioned on only one of the anode or cathode sides.

As discussed above, the gas diffusion layer 100 has an outwardly facing surface 101 having a surface texture or topology. Further, the porous metal coating 110 is applied in a fashion to the outwardly facing surface 101 such that it substantially conforms to the topology. In this regard the porous metal coating is applied in an amount of about 8 to about 150 milligrams of porous metal per square centimeter of the outwardly facing surface area 101. Moreover the porous metal coating 110 is applied in an amount and in a fashion which causes the resulting gas diffusion layer 100 to have an air impedance of about 15 to about 1,000 Gurley seconds. Gurley is defined in this application by the use of a Gurley Model 4118 (low pressure) 0.1 square inch orifice at a flow rate of about 100 cubic centimeters. As will be appreciated from studying FIG. 9, the porous metal coating 110 may be continuous as depicted in that view; or it may be discontinuous based upon other design concerns and desired fuel cell performance parameters. For example, the varied application of the porous metal coating 110 in combination with varying the hydrophobicity of the various portions of the gas diffusion layer 100 has the effect of providing substantially optimal hydration for the underlying ion exchange membrane 80.

The porous metal coating 110, may include a substantially homogenous metal or the respective alloys oxides, nitrides and carbides of same. The metal coating 110 has a density of about 2.0 to about 19.0 grams per cubic centimeter. The porous metal coating may comprise nickel, iron, stainless steel, manganese, zinc, chromium, copper, zirconium, silver, titanium and tungsten and their alloys nitrides, oxides and carbides. For example, when the porous metal coating 110 is formed of nickel, this metal is deposited in an amount of about 28 to about 150 milligrams per square centimeter of surface area. On the other hand, when a porous metal coating of aluminum is employed it is deposited in an amount of about 8 to about 40 milligrams per square centimeter of surface area. As a general matter the porous metal coating 110 has an average thickness of about 25 to about 400 micrometers. The porous metal coating 110 is applied by conventional metal spraying techniques which are well known in the art, and further discussion of these techniques is neither warranted nor required in this application.

As will be understood from FIGS. 1-4 and FIG. 9, the porous metal coating 110 is borne by the outwardly facing surface 101 of the gas diffusion layer 22, 100 and is operable to vary both the hydrophobicity and/or porosity of the gas diffusion layer when the hydrophobicity is measured in a direction substantially along the major surface 25 as seen in FIGS. 1-4. As discussed above, the hydrophobicity and/or porosity of the gas diffusion layer 100 may be varied by the selective application or deposit of the metal coating 110 to provide favorable hydration conditions for the ion exchange membrane 80. Yet further, the deposit or application of the metal coating is varied to provide an enhanced current density for the ion exchange membrane 80, as will be discussed in greater detail below.

As noted above, porous metal coating 110 can be deposited in a manner which provides a continuously or selectively variable hydrophobicity and/or porosity for the gas diffusion layer 100. For example, the deposit of the porous metal coating 110 can be done in a manner to provide a plurality of discrete zones 30 which each have different, yet substantially constant hydrophobicity and/or porosity. Still further, in another alternative form of the invention, the porous metal coating 110 can be deposited in a manner to provide a plurality of discrete zones 30, and wherein at least one of the zones has a continuously variable or different hydrophobicity and/or porosity, and wherein the hydrophobicity and/or porosity of the respective zones are variable or have different relative values.

Referring still to FIG. 9 a fuel cell employing a MEDLA 10 will also include a current collector which is generally designated by the numeral 120, and which rests in ohmic electrical contact against the porous metal coating 110. The current collector 120 is of traditional design having a main body 121 which has open areas 122 formed therein, and which allows a source of fuel 14, such as hydrogen (on the anode side 12); and an oxidant supply 15, such as oxygen (on the cathode side 13); to reach the underlying porous metal coating 110, and associated gas diffusion layer 100. The current collector 120 is typically fabricated from a metal or metal alloy, and/or has a metal coating; cladding; or plating formed of nickel or similar metals. As noted above, the current collector transmits force or pressure 123 which is applied thereto and which maintains the current collector in ohmic electrical contact with the underlying porous metal coating 110. During subsequent fuel cell operation, contact resistance 124 is established between the main body 121 of the current collector 120, and the porous metal coating 110. In this regard with respect to the contact resistance, it has been discovered that the contact resistance, in the present arrangement, is substantially constant and independent of the force applied by way of the current collector 120. In this arrangement, therefore, as shown in FIG. 9, the contact resistance 124 remains substantially constant and independent of the force applied by way of the current collector 120, and the gas diffusion layer 100 has a variable hydrophobicity and/or porosity when measured in a direction which is substantially along the major surface 25. This particular arrangement, therefore, provides for substantially optimal hydration of the ion exchange membrane 80 while simultaneously providing an enhanced current density, and a force independent contact resistance.

Fuel cells are often modeled as a current source in series with a capacitance, and an accompanying electrical resistance. This electrical resistance is referred to as equivalent series resistance or ESR. The ESR of a typical fuel cell comprises, as a general matter, the electrical resistance of the membrane electrode diffusion layer assembly 10 plus the contact resistance 124 which is established between the membrane electrode diffusion layer assembly 10 and the adjacent current collector as shown at 120. In the present invention the ESR of the membrane electrode diffusion layer assembly 10 is substantially independent of the force or pressure applied to same. In relative comparison, the contact resistance 124 which exists between the MEDLA 10 and the adjacent current collector 120 in prior art assemblies, is typically a function of pressure or force which is applied by the current collector.

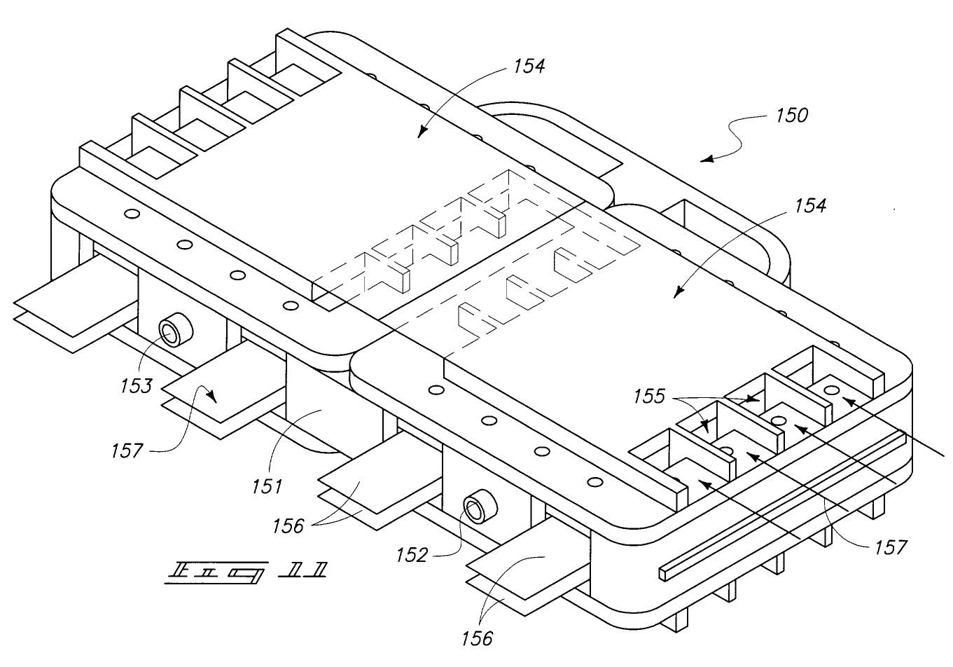

Referring now to FIG. 10, a graph is provided and which shows the relationship of the current produced; fuel cell ESR; and pressure for two different ion exchange membrane fuel cells, each having an approximately 16 square centimeter active, electrode surface area. Each fuel cell utilizes a stainless steel current collector. In this graphic depiction, the earlier prior art relationships are clearly seen. In this regard the line label 130 shows the operational response of a prior art fuel cell which has a membrane electrode diffusion layer assembly 10 with no accompanying porous metal coating 110. As would be expected, as increasing pressure, expressed in terms of pounds per square inch, is applied to the current collector 120, the resulting electrical current output (as expressed in milliamps per square centimeter surface area of the active electrode surface area 83) is shown to rise proportionately. Conversely, and referring to the line labeled 131, for the same prior art ion exchange membrane fuel cell which does not have a porous metal layer or coating 110, it will be seen that the application of increasing pressure or force by way the current collector results in a decrease in the fuel cell ESR. Since the ESR of the membrane electrode diffusion layer assembly is a constant, and substantially independent of the force applied by the adjoining current collector 120, the change in the fuel cell ESR is due almost entirely to a change in the contact resistance. This ESR is expressed in milliohms per square centimeter of surface area. The relationship between current output and pressure applied is quite clear relative to using a prior art non-metalized gas diffusion layer, that is, the application of increasing amounts of pressure results, on the one hand, with decreasing contact resistance, and on the other hand, a corresponding increase in current output of the prior art fuel cell.

Referring still to FIG. 10, the performance of the present invention is graphically depicted with respect to the lines labeled 132 and 133 respectively for a second fuel cell which includes a metalized gas diffusion layer 100. As seen in FIG. 10 line 132 depicts a fuel cell with a stainless steel current collector 120, and wherein the gas diffusion layer 100 of the membrane electrode diffusion layer assembly 10 has a porous metal coating 110 applied thereto. Line 132 illustrates that the current output (as expressed in milliamps per square centimeter of surface area) is substantially constant when exposed to increasing amounts of pressure as applied to, or by way of, the current collector 120. This is, of course, in stark contrast to line 130 which shows the relationship of pressure and current output in a fuel cell which does not have a metal coating 120 applied to the gas diffusion layer 100. Still further line 133 shows the same fuel cell having a porous metal layer or coating 110 applied to the gas diffusion layer 100, and wherein it will be seen that the fuel cell ESR (as expressed in milliohms per square centimeter of surface area) and thus contact resistance, remains substantially constant at pressures of less than about 300 pounds per square inch as applied by the current collector 120. Still further, line 132 and 133 demonstrate that a fuel cell incorporating the MEDLA 10 will operate at pressures which would render most prior art fuel cells nearly inoperable or commercially unattractive in view of the relatively low current outputs that it would provide.

The arrangement as seen in FIG. 9 provides a means by which a relatively inexpensive, and cost efficient fuel cell may be readily assembled while avoiding many of the shortcomings attendant with the prior art practices which include applying relatively sizeable amounts of force in order to provide effective electrical contact between the adjacent current collector 120 and the porous metal coating 110. In addition to the foregoing, one of the perceived shortcomings of the prior art fuel cell designs has been the propensity for such fuel cells to cause the ion exchange membrane to have various regions which have higher relative temperatures than adjacent regions. These higher temperatures have been caused, in part, due to non-uniform hydration of the ion exchange membrane. Further, this is often exacerbated by other design consideration which call for relatively high pressure to be applied in order to effect a lower contact resistance, and higher current outputs. In the present invention however, the gas diffusion layer 100 which is located adjacent to each electrode 83 has a variable hydrophobicity which provides an appropriate degree of hydration for the variable temperature regions that may be created on the ion exchange membrane 80, and which may be caused by the particular design of the fuel cell. The gas diffusion layer 100 which is located adjacent to each electrode 83 may have a plurality of zones 31-33 each having a variable hydrophobicity, and which provides an appropriate hydration for variable temperature regions which may occur on the anode side, cathode side or both sides thereof. Therefore the present invention provides a method of optimizing the operation of a fuel cell which includes providing a fuel cell having an ion exchange membrane 80 with opposite anode and cathode sides 81 and 82, and a surface area; determining the surface area temperature of the ion exchange membrane during operation of the fuel cell to identify regions of the ion exchange membrane which have different temperatures and correspondingly different operational hydration requirements; providing a gas diffusion layer 100 made integral with the ion exchange membrane 80 and which has a variable hydrophobicity and which provides for substantially optimal hydration of the regions of the ion exchange membrane which have a different surface temperature and operational hydration requirements; and regulating the operational temperature of the fuel cell. This temperature regulation is achieved by means of the fuel cell module construction which is discussed in greater detail, below.

Referring now to FIG. 11, a first form of an ion exchange fuel cell module which may incorporate the teachings of present invention 10 is generally indicated by the numeral 150. The fuel cell module, as illustrated, is discussed in significant detail in U.S. Pat. No. 6,030,718 the teachings of which are incorporated by reference herein. As a general matter, the fuel cell module 150, as shown, has a main body 151 which defines internal cavities (not shown) and which receive individual membrane electrode diffusion layer assemblies 10 as illustrated in FIGS. 1-4. In this arrangement, the anode surfaces 12 face inwardly toward these cavities defined by the main body 151, and the cathode sides 13 face outwardly so that they may be exposed to a stream of air which passes over the surface thereof. As should be understood from a study of FIG. 11, and the teachings of U.S. Pat. No. 6,030,718, multiple modules 150 are combined together into an ion exchange membrane fuel cell power system which is similar to that shown in FIG. 13. Still further, the multiple modules each enclose at least one ion exchange membrane. Still further the ion exchange membrane fuel cell power system is arranged such that at least one of the modules can be operationally disabled and removed from service, by hand, while the remaining modules continue to operate. Still further it should be understood that the fuel cell modules 150 produce heat energy during operation. Additionally, each module 150 has an airflow which regulates the operational temperature of each module by removing a preponderance of the heat energy therefrom. In this regard, the first form of the ion exchange membrane fuel cell module 150 has a fuel intake port 152 formed in the main body 151 and which supplies the fuel 14 to the anode sides 12 of the membrane electrode diffusion layer assemblies 10 which are enclosed therein. Still further the main body 151 defines a by product exhaust port 153 which removes waste water, unreacted fuel gas and any other resulting byproducts from the anode sides of the membrane electrode diffusion layer assemblies 10. Still further cathode covers 154 cooperate with the main body 151 and exert force on adjacent current collectors 156 which are placed into ohmic electrical contact relative to the individual membrane electrode diffusion layer assemblies 10. As seen in FIG. 11, the cathode covers 154 define cathode air passageways 155 which allow a stream of air to move therethrough and into contact with the cathode side 13 of the membrane electrode diffusion layer assemblies 10. In this arrangement a cathode airflow 157 is operable to remove a preponderance of the heat energy generated during ion exchange membrane fuel cell module operation. As seen in FIG. 11 current collectors 156 are provided and which are received internally of the main body 151. The current collectors each have an electrically conductive tab 157 which extends outwardly relative to the main body 151 and which may be selectively electrically coupled with an electrical bus (not shown) and which is made integral with an ion exchange membrane fuel cell power system.

A second form of an ion exchange membrane fuel cell module which may incorporate the MEDLA 10, and the other teachings of the present invention is shown at numeral 170 in FIG. 12. This second form of the ion exchange membrane fuel cell module is discussed with greater specificity in U.S. application Ser. No. 09/577,407 the teachings of which are incorporated by reference herein. As a general matter, however, the second form of the ion exchange membrane fuel cell module 170 has a main body 171 which includes a fuel inlet port 172 which delivers a fuel gas 14 to the anode side 12 of the MEDLAs 10 which are enclosed in the fuel cell module 170. Still further the main body 171 also includes a byproduct exhaust port 173 which removes any unreacted fuel gas 14, and any byproducts, such as water from the main body 171. As seen in FIG. 12, the second form of the ion exchange membrane fuel cell module 170 includes opposite anode heat sinks 174 which are disposed in heat removing relation relative to the anode side of the MEDLAs 10 which are incorporated therein. In the arrangement as shown in FIG. 12, at least two MEDLAs 10 are oriented in spaced relationship, one to the other. In this fuel cell module 170, the cathode sides 13 of the respective ion exchange membranes 11 are proximally related, and the anode sides 12 of the respective ion exchange membranes 11 are distally related. The cathode sides are oriented in spaced relation one to the other, and along a cathode air passageway which is generally indicated by the numeral 175. Located in electric current removing relation relative to each of the ion exchange membranes 11 is a current conductor assembly 176 which is operable to releasably electrically couple with an electrical bus (not shown) and which is made integral with a ion exchange membrane exchange fuel cell power system as will be discussed below. As seen in FIG. 12, the ion exchange membrane fuel cell module 170 is provided with a cathode airflow which is generally indicated by the numeral 180. The cathode air flow is bifurcated to provide a first air stream 181 which enters the fuel cell module 170 and passes along the cathode air passageway 175. Still further, a second air stream 182 provides airflow streams that move across the respective anode heat sinks 174. The second air stream 182 regulates in part, the operational temperature of the ion exchange memory fuel cell module 170 by removing a preponderance of the heat energy generated by the ion exchange membrane fuel cell module therefrom. Also in the present arrangement, the first air stream which passes through the cathode air passageway 175 removes less than a preponderance of the heat energy produced during operation of the ion exchange membrane fuel cell module 170.

Referring now to FIG. 13 an ion exchange membrane fuel cell power system is shown and which is generally designated by the numeral 183. As will be seen, multiple ion exchange membrane fuel cell modules 170 are provided. As was the case with the first form of the ion exchange membrane fuel cell module 150, at least one of the modules 170 can be operationally disabled and removed from service by hand, while the remaining modules 170 continue to operate. As seen, the fuel cell power system 183 is provided with a source of fuel which is generally indicated by the numeral 184. The source of fuel may include bottled hydrogen 184 or other similar fuel gases which may be supplied to the respective modules. Still further, a chemical reformer 185 may be provided and which may operate to take a source of a suitable hydrocarbon and react it in such a fashion so as to release a fuel gas, such as hydrogen, which may then be consumed during operation of the ion exchange membrane fuel cell modules 170. The source of fuel gas 183 and/or the chemical reform 184 is coupled to the fuel cell power system 182 by appropriate conduits 186.

### Operation

The operation of the described embodiments of the present invention are believed to be readily apparent and are briefly summarized at this point.

The present invention is best understood by a study of FIGS. 1-4, 9, 11 and 12. As shown therein a fuel cell such as 150 and 170 includes an ion exchange membrane 11 having opposite anode and cathode sides 12 and 13, respectively. An electrode 20 is provided and disposed adjacent to each of the anode and cathode sides. Still further a gas diffusion layer 22 is located adjacent to each electrode and which defines a major surface 25. At least one of the gas diffusion layers has a hydrophobicity which varies when measured in a direction which is substantially along the major surface and which provides a substantially optimal hydration for the ion exchange membrane 11 at fuel cell operational temperatures. Still further a cathode airflow 157, 180 is provided to the fuel cell module 150 and 170 and which is supplied in part to the cathode 13 and which further regulates the operational temperature of the fuel cell.

In the several forms of the invention as described, multiple fuel cell modules such as what is shown at 150 and 170 are provided. These multiple modules each enclose at least one ion exchange membrane 11. The respective fuel cell modules 150, 170 may be incorporated into an ion exchange membrane fuel cell power system as exemplified by the numeral 183, and at least one of the fuel cell modules can be operationally disabled and removed from service, by hand, while the remaining fuel cell modules continue to operate. As earlier discussed each of the fuel cell modules produce heat energy during operation, and each fuel cell module has an airflow such as what is shown at 157 and 180, and which regulates the operational temperature of each fuel cell module by removing heat energy therefrom while simultaneously providing the oxidant supply necessary to maintain fuel cell operation. As earlier discussed with one form of the invention, the cathode airflow 157 may remove a preponderance of the heat energy therefrom. In an alternative form of the invention, the cathode airflow 180 may remove less than a preponderance. As seen with respect to FIG. 12, the cathode airflow 180 is bifurcated into first and second streams 181 and 182, and wherein one of the streams 182 passes over the anode heat sinks 174 and removes a preponderance of the heat energy generated during fuel cell operation therefrom.

As discussed earlier in this application, the gas diffusion layer 22, 100 may have a variable hydrophobicity. This gas diffusion layer 22, 100 may be located on the anode side 12, cathode side 13 or both sides. Still further the gas diffusion layer may have a variable porosity (permeability) which may be varied when measured in the X, and/or Y axes. Still further, and as discussed earlier in this application, the hydrophobicity and/or porosity may be varied to provide both substantially uniform hydration, and an enhanced current density for the ion exchange membrane 11. This hydrophobicity and porosity (permeability) may be substantially continuously variable or in a plurality of zones which may be constant or continuously variable to address temperature variations which may be present along the major surface 25. In each instance, the hydrophobicity and/or porosity may be varied in a number of different ways such as by providing a gas diffusion layer 22, or a gas diffusion layer 100 which may incorporate a porous metal layer 110, in order to provide optimal hydration and enhanced current density for the ion exchange membrane 11.

As discussed earlier in this application a fuel cell is described and which may have an ion exchange membrane 11 having opposite anode and cathode sides 12 and 13 respectively. An electrode 20 is provided and which is disposed in ohmic electrical contact relative to each of the anode and cathode sides. Further a gas diffusion layer 22, 100 is provided and positioned on at least one of the anode and cathode sides 12 and 13 respectively, and which has length, width and thickness dimensions and wherein the length and width dimensions define a major surface 25, and wherein the gas diffusion layer is juxtaposed relative to the electrodes 83, and a porous metal coating 110 is provided, and is borne by the gas diffusion layer and which varies the hydrophobicity of the gas diffusion layer when the hydrophobicity is measured in a direction substantially along the major surface. In addition to providing an ion exchange membrane 80 which has improved hydration and current densities, the present arrangement also provides for a substantially constant and force independent contact resistance to be established between the porous metal coating 110 and an adjacent current collector 120.

Therefore it will be seen that the present invention provides many advantages over the prior art and substantial cost savings can be realized in manufacturing ion exchange membrane fuel cell modules which have enhanced performance characteristics in relative comparison to the prior art devices while simultaneously avoiding many of the detriments associated with the prior art practices.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What we claim is:

1. A fuel cell, comprising:
an ion exchange membrane having opposite anode and cathode sides;
an electrode disposed adjacent to each of the anode and cathode sides;
a gas diffusion layer which is located adjacent to each electrode, and which defines a major surface, and wherein at least one of the gas diffusion layers has a hydrophobicity which varies when measured in a direction which is substantially along the major surface, and which provides a substantially optimal hydration for the ion exchange membrane at fuel cell operational temperatures; and
an air flow provided to the fuel cell and which is supplied, in part, to the cathode, and wherein the air flow further regulates the operational temperature of the fuel cell.

2. A fuel cell as claimed in claim 1, and further comprising:
multiple modules each enclosing at least one ion exchange membrane, and wherein at least one of the modules can be operationally disabled and removed from service, by hand, while the remaining modules continue to operate, and wherein each of the modules produce heat energy during operation, and wherein each module has an air flow which regulates the operational temperature of each module by removing a preponderance of the heat energy therefrom.

3. A fuel cell as claimed in claim 2, and wherein the air flow provided to the module is supplied to the cathode side of the ion exchange membrane, and wherein a preponderance of the heat energy is removed by way of the air flow supplied to the cathode side of the ion exchange membrane.

4. A fuel cell as claimed in claim 2, and wherein the air flow provided to the module is supplied to the cathode side of the ion exchange membrane, and wherein less than a preponderance of the heat energy is removed by way of air flow supplied to the cathode side of the ion exchange membrane.

5. A fuel cell as claimed in claim 2, and further comprising:
an anode heat sink disposed in heat removing relation relative to the anode side of the ion exchange membrane, and wherein the air flow provided to the module is bifurcated into a first stream which is supplied to the cathode side of the ion exchange membrane, and a second stream which passes over the anode heat sink, and wherein the preponderance of heat energy is removed from the module by way of the second stream.

6. A fuel cell as claimed in claim 1, and further comprising:
multiple modules each enclosing at least two ion exchange membranes that are oriented in spaced relation one to the other, and wherein the cathode sides of the respective ion exchange membranes are proximally related, and the anode sides of the respective ion exchange membranes are distally related, and wherein at least one of the modules can be operationally disabled and removed from service, by hand, while the remaining modules continue to operate, and wherein the air flow regulates the operational temperature of the module by removing a preponderance of the heat energy therefrom.

7. A fuel cell as claimed in claim 6, and wherein the at least one gas diffusion layer having a variable hydrophobicity is juxtaposed relative to the anode side of the ion exchange membrane.

8. A fuel cell as claimed in claim 6, and wherein the at least one gas diffusion layer having a variable hydrophobicity is juxtaposed relative to the anode and cathode sides of the ion exchange membrane.

9. A fuel cell as claimed in claim 6, and wherein the major surface of the gas diffusion layer which has the variable hydrophobicity is substantially planar, and wherein the length and width dimensions are defined by an X and Y axes, and the thickness dimension is defined by a Z axis, and wherein the hydrophobicity varies when measured in the X axis.

10. A fuel cell as claimed in claim 6, and wherein the major surface of the gas diffusion layer which has the variable hydrophobicity is substantially planar, and wherein the length and width dimensions are defined by an X and Y axes, and the thickness dimension is defined by a Z axis, and wherein the hydrophobicity varies when measured in the Y axis.

11. A fuel cell as claimed in claim 6, and wherein the major surface of the gas diffusion layer which has the variable hydrophobicity is substantially planar, and wherein the length and width dimensions are defined by an X and Y axes, and the thickness dimension is defined by a Z axis, and wherein the hydrophobicity varies when measured in both the X and Y axes.

12. A fuel cell as claimed in claim 6, and wherein the major surface of the gas diffusion layer which has the variable hydrophobicity is substantially planar, and wherein the length and width dimensions are defined by an X and Y axes, and the thickness dimension is defined by a Z axis, and wherein the hydrophobicity varies when measured in the X, Y and Z axes.

13. A fuel cell as claimed in claim 1, and wherein the hydrophobicity varies when measured in the length dimension.

14. A fuel cell as claimed in claim 1, and wherein the hydrophobicity varies when measured in the width dimension.

15. A fuel cell as claimed in claim 1, and wherein the hydrophobicity varies when measured in both the length and width dimensions.

16. A fuel cell as claimed in claim 1, and wherein the hydrophobicity varies when measured in the length, width and thickness dimensions.

17. A fuel cell as claimed in claim 1, and wherein the gas diffusion layer further has a porosity which varies when measured in a direction which is substantially along the major surface.

18. A fuel cell as claimed in claim 1, and wherein the gas diffusion layer further has a porosity which varies both when measured in a direction which is substantially along the major surface, and in the thickness dimension

19. A fuel cell as claimed in claim 1, and wherein the gas diffusion layer has a porosity, and wherein the major surface is substantially planar, and wherein the length and width dimensions are defined by an X and Y axes, and the thickness dimension is defined by a Z axis, and wherein the porosity varies when measured in the X axis.

20. A fuel cell as claimed in claim 1, and wherein the gas diffusion layer has a porosity, and wherein the major surface is substantially planar, and wherein the length and width dimensions are defined by an X and Y axes, and the thickness dimension is defined by a Z axis, and wherein the porosity varies when measured in the Y axis.

21. A fuel cell as claimed in claim 1, and wherein the gas diffusion layer has a porosity, and wherein the major surface is substantially planar, and wherein the length and width dimensions are defined by an X and Y axes, and the thickness dimension is defined by a Z axis, and wherein the porosity varies when measured in both the X and Y axes.

22. A fuel cell as claimed in claim 1, and wherein the gas diffusion layer has a porosity, and wherein the major surface is substantially planar, and wherein the length and width dimensions are defined by an X and Y axes, and the thickness dimension is defined by a Z axis, and wherein the porosity varies when measured in the X, Y and Z axes.

23. A fuel cell as claimed in claim 1, and which further comprises:
an oxidant supply coupled in fluid flowing relation relative to the cathode side of the ion exchange membrane; and
a fuel supply coupled in fluid flowing relation relative to the anode side of the ion exchange membrane, and wherein the oxidant and fuel supplies each have a direction of flow relative to the major surface, and wherein the hydrophobicity varies when measured in substantially the same general direction of flow of the fuel supply.

24. A fuel cell as claimed in claim 1, and further comprising:
an oxidant supply coupled in fluid flowing relation relative to the cathode side of the ion exchange membrane; and
a fuel supply coupled in fluid flowing relation relative to the anode side, and wherein the oxidant, and fuel supplies are each introduced to the ion exchange membrane at a first location along the major surface, and further any remaining fuel, oxidant or any byproducts are removed from the ion exchange membrane at a second location along the major surface, and wherein the oxidant and fuel supplies move in a path of travel between the first and second locations, and wherein the hydrophobicity varies when measured along each of the respective paths of travel.

25. A fuel cell as claimed in claim 1, and further comprising:
an oxidant supply coupled in fluid flowing relation relative to the cathode side of the ion exchange membrane; and
a fuel supply coupled in fluid flowing relation relative to the anode side, and wherein the oxidant and fuel supplies are each introduced to the ion exchange membrane and each have a primary, substantially linear direction of flow, and wherein the primary direction of flow of each is defined between a first location wherein the fuel or oxidant supply is introduced to the ion exchange membrane, and a second location wherein any remaining fuel or oxidant or oxidant supply, and any byproducts are removed from the ion exchange membrane, and wherein the hydrophobicity of the ion exchange membrane is greatest at a location adjacent the first location and is least when located adjacent the second location.

26. A fuel cell as claimed in claim 1, and further comprising:
an oxidant supply coupled in fluid flowing relation relative to the cathode side of the ion exchange membrane; and
a fuel supply coupled in fluid flowing relation relative to the anode side, and wherein the oxidant and fuel supplies are each introduced to the ion exchange membrane and each have a primary, substantially linear direction of flow, and wherein the primary direction of flow of each is defined between a first location wherein the fuel or oxidant supply is introduced to the ion exchange membrane, and a second location wherein any remaining fuel or oxidant supply, and any byproducts, are removed from the ion exchange membrane, and wherein the hydrophobicity of the ion exchange membrane is least at a location adjacent the first location, and is the greatest when located adjacent the second location.

27. A fuel cell as claimed in claim 1, and wherein the hydrophobicity varies to provide substantially uniform hydration of the ion exchange membrane.

28. A fuel cell as claimed in claim 1, and wherein the hydrophobicity varies to provide a substantially enhanced current density for the ion exchange membrane.

29. A fuel cell as claimed in claim 1, and wherein the hydrophobicity varies to provide both a substantially uniform hydration and an enhanced current density for the ion exchange membrane.

30. A fuel cell as claimed in claim 1, and wherein the hydrophobicity is substantially continuously variable.

31. A fuel cell as claimed in claim 1, and wherein the gas diffusion layer includes discrete zones which each have a substantially constant hydrophobicity, and wherein the hydrophobicity of the respective zones is variable.

32. A fuel cell as claimed in claim 1, and wherein the gas diffusion layer includes a plurality of discrete zones, and wherein at least one of the zones has a continuously variable hydrophobicity, and wherein the hydrophobicity of the respective zones are variable.

33. A fuel cell as claimed in claim 1, and wherein the gas diffusion layer includes discrete zones which each have a substantially similar surface area, and wherein the hydrophobicity of the discrete zones is variable.

34. A fuel cell as claimed in claim 1, and wherein the gas diffusion layer includes a plurality of discrete zones, and wherein at least one of the discrete zones has a surface area which is dissimilar from the remaining zones, and wherein the hydrophobicity of the discrete zones is variable.

35. A fuel cell as claimed in claim 1, and wherein the gas diffusion layer includes a plurality of discrete zones, each of which has a surface area, and wherein the hydrophobicity and surface area of the respective zones are varied to provide a substantially favorable hydration of the ion exchange membrane.

36. A fuel cell as claimed in claim 1, and wherein the gas diffusion layer includes a plurality of discrete zones, each of which has a surface area, and wherein the hydrophobicity and surface area of the respective zones are varied to provide a substantially enhanced current density for the ion exchange membrane.

37. A fuel cell as claimed in claim 1, and wherein the gas diffusion layer includes a plurality of discrete zone, each of which has a surface area, and wherein the hydrophobicity and the surface area of the respective zones are varied to provide both a substantially favorable hydration and an enhanced current density for the ion exchange membrane.

38. A fuel cell as claimed in claim 1, and wherein the gas diffusion layer includes a plurality of discrete zones, each of which has a surface area and a porosity, and wherein the porosity and the surface area of the respective zones are varied to provide a substantially favorable hydration of the ion exchange membrane.

39. A fuel cell as claimed in claim 1, and wherein the ion exchange membrane includes a plurality of discrete zones, each of which has a surface area and a porosity, and wherein the hydrophobicity, porosity and surface area of the respective zones are varied to provide both a substantially optimal hydration and an enhanced current density for the ion exchange membrane.

40. A fuel cell comprising:
an ion exchange membrane having opposite anode and cathode sides;
an electrode juxtaposed relative to each of the anode and cathode sides; and
a gas diffusion layer juxtaposed relative to each electrode and which is defined by X, Y and Z axes, and wherein at least one of the gas diffusion layers further has both a variable porosity and hydrophobicity when measured in the X and Y axes.

41. A fuel cell as claimed in claim 40, and wherein the gas diffusion layer has an outwardly facing surface, an opposite inwardly facing surface which is adjacent to the electrode, and a thickness dimension, and wherein the outwardly facing surface is substantially coplanar with the X and Y axes, and the thickness dimension is substantial coaxial with the Z axis.

42. A fuel cell as claimed in claim 41, and wherein the porosity and hydrophobicity is substantially continuously variable when measured in a direction along the X and Y axes.

43. A fuel cell as claimed in claim 41, and wherein the porosity and hydrophobicity is discontinuously variable when measured in a direction along the X and Y axes.

44. A fuel cell as claimed in claim 40, and wherein the at least one gas diffusion layer having the variable porosity and hydrophobicity is defined by a plurality of zones, and wherein the porosity and the hydrophobicity of each zone is substantially constant, and wherein the porosity and hydrophobicity of the respective zones are variable.

45. A fuel cell as claimed in claim 40, and wherein the gas diffusion layer having the variable porosity and hydrophobicity is defined by a plurality of zones, each having a different porosity and hydrophobicity, and wherein at least one of the zones has a porosity and hydrophobicity which is substantially continuously variable in a direction along the X and Y axes.

46. A fuel cell as claimed in claim 40, and wherein the gas diffusion layer having the variable porosity and hydrophobicity is defined by a plurality of zones, and wherein alternating zones have substantially the same porosity and hydrophobicity.

47. A fuel cell as claimed in claim 40, and wherein the gas diffusion layer having the variable porosity and hydrophobicity is defined by a plurality of alternating pairs of zones, and wherein a first pair of alternating zones have substantially continuously variable porosity and hydrophobicity when measured in a direction along the X and Y axes, and a second pair of alternating zones have a substantially constant hydrophobicity and porosity when measured in the same given direction along the X and Y axes.

48. A fuel cell as claimed in claim 40, and wherein the gas diffusion layer located on the anode side has a predetermined porosity and hydrophobicity, and the gas diffusion layer located to the cathode side has a porosity and hydrophobicity which is greater than the anode side.

49. A fuel cell as claimed in claim 40, and wherein the gas diffusion layer located on the anode side has a predetermined porosity and hydrophobicity, and the gas diffusion layer located on the cathode side has a porosity and hydrophobicity which is less than the anode side.

50. A fuel cell as claimed in claim 40, and wherein the fuel cell has a fuel gas flow which is defined by a primary axis which lies substantially in the same plane as the X and Y axes, and which is supplied to the anode side of the ion exchange membrane, and wherein the porosity and hydrophobicity varies in substantially the same direction as the primary axis.

51. A fuel cell comprising:
an ion exchange membrane having opposite anode and cathode sides;
an electrode juxtaposed relative to each of the anode and cathode sides;
a gas diffusion layer positioned on at least one of the anode or cathode sides and which has a length, width and thickness dimension, and inwardly and outwardly facing surfaces, and wherein the length and width dimensions define a major surface, and wherein the inwardly facing surface of the gas diffusion layer is juxtaposed relative to the electrode; and
a porous metal coating borne by the outwardly facing surface of the gas diffusion layer, and which varies the hydrophobicity of the gas diffusion layer when the hydrophobicity is measured in a direction substantially along the major surface.

52. A fuel cell as claimed in claim 51, and wherein the hydrophobicity of the gas diffusion layer is varied to provide favorable hydration of the ion exchange membrane.

53. A fuel cell as claimed in claim 51, and wherein the hydrophobicity of the gas diffusion layer is varied to provide an enhanced current density for the ion exchange membrane.

54. A fuel cell as claimed in claim 51, and wherein the porous metal coating comprises one or more elements selected from the periodic table of elements and which has an atomic number of less than 75, and wherein the porous metal coating is positioned in at least partial covering relation relative to the outwardly facing surface of the gas diffusion layer.

55. A fuel cell as claimed in claim 51, and wherein the outwardly facing surface of the gas diffusion layer has a topology, and wherein the porous metal coating substantially conforms to the topology, and is deposited in an amount which causes the resulting gas diffusion layer to have an air impedance of about 23 to about 1,000 Gurley seconds.

56. A fuel cell as claimed in claim 51, and further comprising:
a current collector forcibly disposed in ohmic electrical contact with the porous metal coating, and wherein a contact resistance is established between the current collector and the adjacent porous metal coating, and wherein the contact resistance is substantially constant and independent of the force applied by way of the current collector.

57. A fuel cell as claimed in claim 51, and wherein the porous metal coating is continuous.

58. A fuel cell as claimed in claim 51, and wherein the porous metal coating is discontinuous.

59. A fuel cell as claimed in claim 51, and wherein outwardly facing surface of gas diffusion layer has a surface area, and wherein the porous metal coating is deposited on the outwardly facing surface of the gas diffusion layer in an amount of about 8 to about 150 milligrams per square centimeter of surface area.

60. A fuel cell as claimed in claim 51, and wherein the porous metal coating provides a continuously variable hydrophobicity for the gas diffusion layer.

61. A fuel cell as claimed in claim 51, and wherein the porous metal coating provides a plurality of discrete zones, each of which has a substantially constant hydrophobicity, and wherein the hydrophobicity of the respective zones is variable.

62. A fuel cell as claimed in claim 51, and wherein the porous metal coating provides a plurality of discrete zones, and wherein at least one of the zones has a continuously variable hydrophobicity, and wherein the hydrophobicity of the respective zones are variable.

63. A fuel cell as claimed in claim 51, and wherein the gas diffusion layer has a variable porosity when measured in a direction which is substantially along the major surface, and wherein the porosity and the hydrophobicity of the gas diffusion layer are varied to provide a substantially favorable hydration of the ion exchange membrane.

64. A fuel cell as claimed in claim 51, and wherein the gas diffusion layer has a variable porosity when measured in a direction which is substantially along the major surface, and wherein the porosity and the hydrophobicity of the gas diffusion layer are varied to provide an enhanced current density for the ion exchange membrane.

65. A fuel cell as claimed in claim 51, and further comprising:
a current collector forcibly disposed in ohmic electrical contact with the porous metal coating, and wherein a contact resistance is established between the current collector and the adjacent porous metal coating, and wherein the contact resistance is substantially constant and independent of the force applied by way of the current collector, and wherein the gas diffusion layer has a variable porosity when measured in a direction which is substantially along the major surface, and wherein the porosity and the hydrophobicity of the gas diffusion layer provides an enhanced current density for the ion exchange membrane.

67. A fuel cell, comprising:
an ion exchange membrane having opposite anode and cathode sides;
an electrode disposed adjacent to each of the anode and cathode sides, and wherein the ion exchange membrane, during operation of the fuel cell, has a variable temperature region which has a higher relative temperature than an adjacent region; and
a gas diffusion layer which is located adjacent to one of the electrodes, and wherein the gas diffusion layer has a variable hydrophobicity which provides an appropriate hydration for the variable temperature regions of the ion exchange membrane.

68. A fuel cell, comprising:
an ion exchange membrane having opposite anode and cathode sides;
an electrode disposed adjacent to each of the anode and cathode sides, and wherein the fuel cell, during operation, has an operational temperature range, and wherein the ion exchange membrane, during operation, has a region which has a higher relative temperature than an adjacent region;
a gas diffusion layer which is located adjacent to each electrode, and wherein at least one of the gas diffusion layers has a variable hydrophobicity which provides an appropriate hydration for the variable temperature regions of the ion exchange membrane; and
an air flow provided to the fuel cell, and the cathode thereof, and wherein the air flow, in part, regulates the operational temperature of the fuel cell.

69. A method for optimizing the operation of a fuel cell, comprising:
providing a fuel cell having an ion exchange membrane with opposite anode and cathode sides, and a surface area;
determining the surface area temperature of the ion exchange membrane during operation of the fuel cell to identify regions of the ion exchange membrane which have different temperatures and correspondingly different operational hydration requirements;
providing a gas diffusion layer made integral with the ion exchange membrane, and which has a variable hydrophobicity which provides for substantially optimal hydration for the regions of the ion exchange membrane which have a different surface temperature and operational hydration requirements; and
regulating the operational temperature of the fuel cell.
